(19) United States
(12) Patent Application Publication
(10) Pub. No.: US 2026/0339790 A1
(43) Pub. Date: Oct. 29, 2026

(54) FACILITATING ON-DEMAND REPLAY TO ALLOW FOR RESTORING BACKED-UP FILES IN ADVANCED NETWORKS

(71) Applicant: Dell Products L.P., Round Rock, TX (US)

(72) Inventors: Abinas Tewari, Charlotte, NC (US); Yi Qian, Upton, MA (US); Karunaker Chinthapatla, Westboro, MA (US); Atif Sharif Rao, Shrewsbury, MA (US); Anchal Atlani, McKinney, TX (US); Kaan Aydogan, Westford, MA (US); Justin Mercier, Woonsocket, RI (US); Swapnil Patil, Concord, NC (US); Amar Karmilla, Ashland, MA (US)

(21) Appl. No.: 19/189,080

(22) Filed: Apr. 24, 2025

(51) Int. Cl. G06F 11/1446

(52) U.S. Cl. CPC G06F 11/1469; G06F 11/1464; G06F 2201/84

(57) ABSTRACT

Facilitating on-demand replay to allow for restoring backed-up files in advanced networks is provided. A method includes, based on at least one defined criterion, evaluating, by a system comprising at least one processor, assets of a group of assets for conformance with the at least one defined criterion, resulting in a conforming asset. The group of assets is stored in a data domain. The method also includes transforming, by the system, the conforming asset into a mirrored asset that is temporarily retained in at least one resultant storage medium. Further, the method includes facilitating, by the system via a user equipment, a rendering of the mirrored asset as a replay asset.

### BACKGROUND

A network-attached storage (NAS) platform can serve as a storage environment for various types of data, which can provide a functionally unlimited amount of storage space for multiple users via a seamless single volume and a single file system. In NAS deployments, indexing consumes a large amount of resources (e.g., disk-space, CPU/memory, and also input/output (I/O)). If a user wants to search for different assets that need to be backed-up, a large of amount of resources need to be allocated for the task. For example, search nodes can be deployed, which utilize a large amount of disk space, such as, for example, one terabyte of disk space. The search nodes also consume of large amount of memory and processing resources in order to store the information and/or metadata information to allow the user to search the different assets.

The above-described context with respect to replay in order to restore backed-up files is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes, based on at least one defined criterion, evaluating, by a system comprising at least one processor, assets of a group of assets for conformance with the at least one defined criterion, resulting in a conforming asset. The group of assets is stored in a data domain. In an example, the evaluating can include using multiple connection channels to access the data domain. The method also includes transforming, by the system, the conforming asset into a mirrored asset that is temporarily retained in at least one resultant storage medium. In an example, the transforming can include mirroring the conforming asset into the mirrored asset that is temporarily retained in the at least one resultant storage medium. Further, the method includes facilitating, by the system via a user equipment, a rendering of the mirrored asset as a replay asset.

According to some implementations, the method includes, prior to the evaluating, receiving, by the system, a request for replay of at least a portion of the assets of the group of assets, the request for replay comprises information indicative of the at least one defined criterion. Further to these implementations, a criterion of the at least one defined criterion comprises a date range. In some implementations, a criterion of the at least one defined criterion comprises information indicative of one or more directories.

The method can include, according to some implementations, assigning, by the system, checkpoints at defined stages of the evaluating. The checkpoints restore points from which a restart of the evaluating is able to resume after a stoppage of the evaluating. In some implementations, the method can include defining, by the system, a storage threshold applicable to the mirrored asset and other mirrored assets other than the mirrored asset. Further to these implementations, the method can include, based on a determination that the storage threshold is satisfied, deleting, by the system, the mirrored asset from the at least one resultant storage medium.

Another embodiment relates to a system that includes at least one processor and at least one memory that stores executable instructions that, when executed by the at least one processor, facilitate performance of operations. The operations can include selecting, based on filter parameters, assets from a group of assets stored in a network-attached storage, resulting in selected assets. The operations can also include replicating the selected assets to a temporary storage database, resulting in replicated assets. A virtual machine comprises the temporary storage database. Further, the operations can include outputting the selected assets to be rendered via a user interface of a user equipment. The outputting is performed in response to the replicating of the selected assets being completed or concurrently with the replicating of the selected assets.

In an example, the filter parameters are user-configurable parameters associated with the group of assets. The filter parameters can include a data range, first information indicative of file folders, and second information indicative of directories.

According to some implementations, the selecting can include fuse mounting a storage unit directory that comprises network-attached storage slices retained in the network-attached storage. The fuse mounting can include establishing multiple data channels between the network-attached storage and the virtual machine.

In some implementations, the operations can include monitoring a storage level of the temporary storage database and, based on a determination that the storage level is within a defined value of a threshold storage level, temporarily disabling a replay process. In an alternative, or additional, implementation, the operations can include monitoring a storage level of the temporary storage database and, based on a determination that the storage level is within a defined value of a threshold storage level, deleting the selected assets from the temporary storage database.

Yet another embodiment relates to a non-transitory machine-readable medium, comprising executable instructions that, when executed by at least one processor of network equipment, facilitate performance of operations. The operations can include receiving a selection of filters associated with a replay request. The operations can also include, based on the replay request and the selection of filters, reading a group of data assets of a database storage directory. The reading is performed individually for respective data assets of the group of data assets. Further, the operations can include, based on a determination that a data asset of the group of data assets satisfies the selection of filters, replicating the data asset to a temporary database of a virtual machine, resulting in a replicated data asset. The temporary database is a searchable database. Additionally, the operations can include rendering, via a user interface, the replicated data asset in response to the replay request.

According to an example, the receiving comprises receiving the selection of filters via an interactive user interface. In another example, the replay request comprises an instruction to restore back-up files from a network attached storage database.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, data storage system and associated workflow in accordance with one or more embodiments described herein;

FIG. 2 illustrates an example, non-limiting, computer-implemented method that facilitates on-demand indexing to allow for restoring backed-up files in advanced networks in accordance with one or more embodiments described herein;

FIG. 3 illustrates an example, non-limiting, computer-implemented method that facilitates an indexing process for on-demand indexing in accordance with one or more embodiments described herein;

FIG. 4 illustrates an example, non-limiting, user interface depicting a first stage of a restoration process in accordance with one or more embodiments described herein;

FIG. 5 illustrates an example, non-limiting, user interface depicting a second stage of the restoration process in accordance with one or more embodiments described herein;

FIG. 6 illustrates an example, non-limiting, user interface depicting a third stage of the restoration process in accordance with one or more embodiments described herein;

FIG. 7 illustrates an example, non-limiting, user interface depicting a fourth stage of the restoration process in accordance with one or more embodiments described herein;

FIG. 8 illustrates an example, non-limiting, user interface depicting a fifth stage of the restoration process in accordance with one or more embodiments described herein;

FIG. 9 illustrates an example, non-limiting, user interface depicting a sixth stage of the restoration process in accordance with one or more embodiments described herein;

FIG. 10 illustrates an example, non-limiting, system for facilitating on-demand indexing to allow for restoring backed-up files for network-attached storage and/or filesystems in advanced networks in accordance with one or more embodiments described herein;

FIG. 11 illustrates an example, non-limiting, computer-implemented method that facilitates on-demand restoration of assets based on one or more criteria in advanced networks in accordance with one or more embodiments described herein;

FIG. 12 illustrates an example, non-limiting, computer-implemented method that facilitates on-demand replay to allow for restoring backed-up files while conserving computing resources in advanced networks in accordance with one or more embodiments described herein;

FIG. 13 illustrates an example, non-limiting, computing environment in which one or more embodiments described herein can be facilitated; and

FIG. 14 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

As mentioned above, a network-attached storage (NAS) platform can serve as a storage environment for various types of data, which can provide a functionally unlimited amount of storage space for multiple users via a seamless single volume and a single file system. In NAS deployments, indexing consumes a large amount of resources (e.g., disk-space, CPU/memory, and also I/O). If a user wants to search for different assets that have to be backed-up, a large of amount of resources need to be allocated. For example, search nodes can be deployed, which utilize a large amount of disk space, such as, for example, one terabyte of disk space. The search nodes also consume of large amount of memory and processing resources in order to store the information and/or metadata information to allow the user to search the different assets.

An issue with NAS, FileSystems (FSs), and the like, is that indexing consumes a large amount of resources such as, for example, disk-space, CPU and/or memory, I/O, and so on. If an end goal is to perform a restore operation on some files through a search interface, for example, then a manner of greatly reducing the storage and CPU requirements can be achieved by soliciting the user for a narrow date range or list of assets for which the user wants to perform the restore operation, as discussed herein. In such a manner, no longer is terabytes of disk space, and multiple dedicated indexing nodes required to perform the desired search and restore operation. Further, the disclosed embodiments facilitate a workflow to solicit various filter parameters from the user and allow for some time to perform on-demand indexing of desired metadata.

In further detail, provided herein is an interactive user interface where searchable databases are created for the user based on the user's needs. These temporary databases are used for a specific period to perform search and restore operations. Upon or after expiration of the defined period, the temporary databases can be deleted in order to free up storage and other processing capabilities. As utilized herein, a user can be an entity including, but not limited to, one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

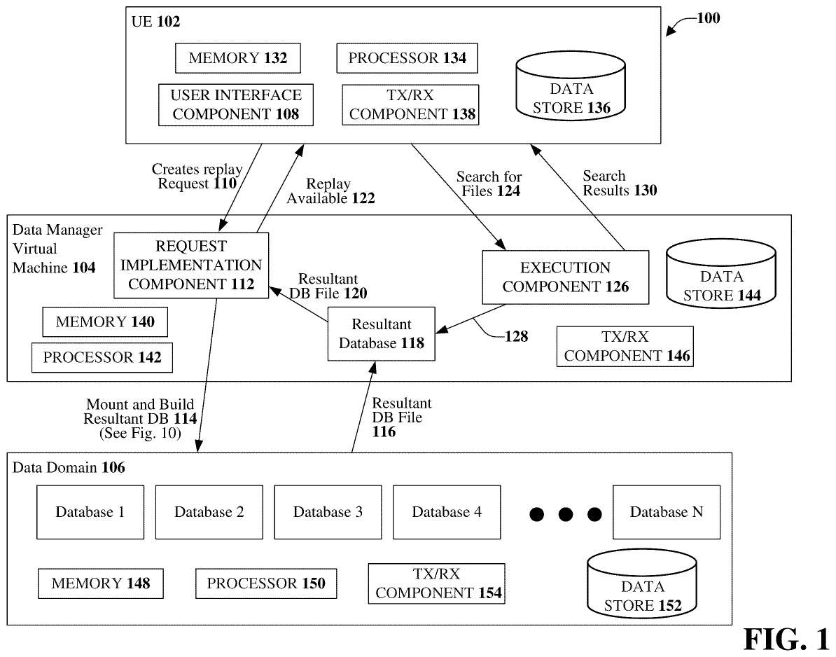

FIG. 1 illustrates an example, non-limiting, data storage system 100 and associated workflow in accordance with one or more embodiments described herein. Aspects of systems (e.g., the data storage system 100 and the like), devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the data storage system 100 can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the data storage system 1000 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As illustrated, the data storage system 100 can include one or more user equipment (UE 102), a data manager virtual machine (data manager VM 104), and a data domain 106. A virtual machine is a compute resource that uses software (not a physical computer) to execute programs and deploy applications. In some implementations, one or more virtual machines (e.g., guest machines) execute on a physical machine (e.g., a host machine). In an example, the data manager VM 104 is a Linux® Virtual Machine. However, the disclosed embodiments are not limited to a Linux® deployment and other types of operating systems can be utilized.

The UE 102 includes a user interface component 108 that allows the user or other entity to interact with the data manager VM 104. Via the user interface component 108, the user can select one or more assets (e.g., directories, files, databases, and so on) to restore and/or from which one or more assets are to be restored. The user can also select, via the user interface component 108, one or more filters that should be applied for the restoration. The filters can include, but are not limited to, a date range, information indicative of one or more file folders, information indicative of one or more directories, and so on. The various filters can be utilized to narrow down a search space and the number of assets that need to be evaluated in order to restore such assets. The one or more filters can also be utilized to limit the number of assets to be restored to a manageable size and/or to conserve storage space associated with the restoration of the one or more assets.

Upon or after the filters are selected, as indicated by line 110, a process replay request is received by a request implementation component 112. As utilized herein replaying from a network-attached storage (NAS) device involves navigating to the NAS directory within the file selection screen and then selecting the desired file to play. Replay is used to indicate what should be stored in a temporary database.

Upon or after receipt of the process replay request and an indexing task can begin execution (e.g., can be started, can be ran). A duration of the indexing task can be anywhere from a few minutes (or less) to one or more days. The duration of the indexing task is a function of a size of an NAS share and/or a size of the FS.

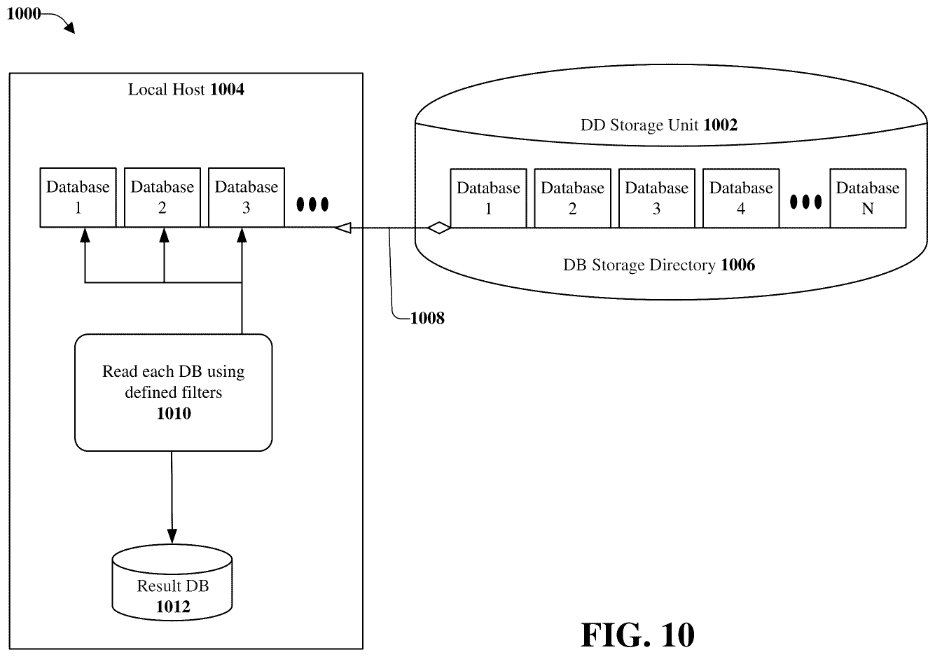

In further detail, upon or after the process replay request is received, by the request implementation component 112, instructions related to mounting and building a resultant database are transmitted (as indicated at 114) to the data domain 106. For example, the instructions (sent at 114) can include instructions to mount and build a resultant database, which will be discussed in further detail below with respect to FIG. 10.

As depicted, the data domain 106 includes one or more databases, which can be serverless, embedded relational database, such as, for example, an SQL Lite® database, however, other types of databases can be utilized. The databases in the data domain 106 are indicated as a first database (database 1), a second database (database 2), a third database (database 3), a fourth database (database 4), and so on, through an Nth database (DB N). Although more than four databases are shown and described, any number of databases (even fewer than four databases) can be included in the data domain 106 and can be the subject of replay as discussed herein.

Information indicative of a resultant database file is communicated, at 118, to the data manager VM 104 and stored as a resultant database file 118 in the data manager VM 104. Upon or after the resultant database file 118 is stored in the data manager VM 104, information indicative of that file is communicated, at 120, to the request implementation component 112. Information indicative of the availability of the replay is conveyed, at 122, to the UE 102. The notice as to the availably can be performed after all the assets are recovered, or any period during the recovery of the file, such as real-time updates after one or more portions of the assets have been recovered (e.g., real-time updates).

According to some implementations, real-time updates are transmitted to the UE 102 and causes the UE 102 to activate the user interface component 108 with the time critical updated information so that the user becomes aware of the update in real-time. Based on this real-time update, the user can begin to use one or more assets that have been restored, manipulate the assets, and/or perform other functions with respect to the assets based on knowing, in real-time, that the restored assets are available. For assets that take hours or days to restore, such real-time notifications can allow the user to begin working with the files before all the files are restored, which can increase an efficiency of the user and/or processing resources (including storage resources). In some implementations, by the user working with the files in real-time, as such assets are restored, processing resources can be conserved because the user might be able to perform the one or more desired function with the assets, and remove (e.g., delete) the restored assets sooner than would be possible if the real-time updates not been available and had the user not begin working with the assets as they became available.

As indicated at 124, the user, via the user interface component 108 or another component of the UE 102, can search for files. Upon or after receipt of the file request search, an execution component 126, processes the request and runs (e.g., executes) one or more queries on the resultant database file 118, as indicated at 128. Upon or after completion of execution of the one or more queries, or upon or after completion of portions thereof, the search results are communicated, at 130, to the UE 102 (e.g., via the user interface component 108).

As illustrated, the UE 102 can include at least one memory 132, at least one processor 134, at least one data store 136, and a transmitter/receiver component 138 (Tx/Rx component). Further, according to some implementations, the data manager VM 104 can include, or can be associated with, at least one memory 140, at least one processor 142, at least one data store 144, and a transmitter/receiver component 146 (Tx/Rx component). Additionally, the data domain 106 can include, or can be associated with, at least one memory 148, at least one processor 150, at least one data store 152, and a transmitter/receiver component 154 (Tx/Rx component).

The respective memories (e.g., the at least one memory 132, the at least one memory 140, the at least one memory 148) can store computer executable components and instructions. The respective processors (e.g., the at least one processor 134, the at least one processor 142, the at least one processor 150) can facilitate execution of the instructions (e.g., computer executable components and corresponding instructions) by the respective other system components. For example, the at least one processor 134 can facilitate execution of instructions implemented via the user interface component 108 and/or other components of the UE 102. In another example, the at least one processor 142 can facilitate execution of instructions implemented via the request implementation component 112, the execution component 126, the transmitter/receiver component 146, and/or other components of the data manager VM 104. In yet another example, the at least one processor 150 can facilitate execution of instructions implemented via components of the data domain 106.

In some embodiments, one or more of the user interface component 108, the at least one memory 132, the at least one processor 134, the at least one data store 136, and the transmitter/receiver component 138 can be electrically, communicatively, and/or operatively coupled to one another to perform one or more functions of the UE 102. According to some embodiments, one or more of the request implementation component 112, the execution component 126, the at least one memory 140, the at least one processor 142, the at least one data store 144, and the transmitter/receiver component 146 can be electrically, communicatively, and/or operatively coupled to one another to perform one or more functions of the data manager VM 104. Further, in some implementations, one or more of the at least one memory 148, the at least one processor 150, the at least one data store 152, and the transmitter/receiver component 154 can be electrically, communicatively, and/or operatively coupled to one another to perform one or more functions of the data domain 106.

According to some implementations, the user interface component 108 (as well as other interface components discussed herein) can provide a Graphical User Interface (GUI), a command line interface, a speech interface, Natural Language text interface, and the like. For example, a GUI can be rendered that provides an entity with a region or means to load, import, select, read, and so forth, various requests and can include a region to present the results of the various requests. These regions can include known text and/or graphic regions that include dialogue boxes, static controls, drop-down-menus, list boxes, pop-up menus, edit controls, combo boxes, radio buttons, check boxes, push buttons, graphic boxes, and so on. In addition, utilities to facilitate the information conveyance, such as vertical and/or horizontal scroll bars for navigation and toolbar buttons to determine whether a region will be viewable, can be employed. Thus, it might be inferred that the entity did want the action performed.

The entity can also interact with the regions to select and provide information through various devices such as a mouse, a roller ball, a keypad, a keyboard, a pen, gestures captured with a camera, a touch screen, and/or voice activation, for example. According to an aspect, a mechanism, such as a push button or the enter key on the keyboard, can be employed subsequent to entering the information in order to initiate information conveyance. However, it is to be appreciated that the disclosed aspects are not so limited. For example, merely highlighting a check box can initiate information conveyance. In another example, a command line interface can be employed. For example, the command line interface can prompt the entity for information by providing a text message, producing an audio tone, or the like. The entity can then provide suitable information, such as alphanumeric input corresponding to an option provided in the interface prompt or an answer to a question posed in the prompt. It is to be appreciated that the command line interface can be employed in connection with a GUI and/or Application Program Interface (API). In addition, the command line interface can be employed in connection with hardware (e.g., video cards) and/or displays (e.g., black and white, and Video Graphics Array (VGA)) with limited graphic support, and/or low bandwidth communication channels.

The respective memories (e.g., the at least one memory 132, the at least one memory 140, the at least one memory 148) can be operatively connected to the respective processor (e.g., the at least one processor 134, the at least one processor 142, the at least one processor 150). The respective memories can store executable instructions and/or computer executable components (e.g., the user interface component 108 and the transmitter/receiver component 138; the request implementation component 112, the execution component 126, and the transmitter/receiver component 146; the transmitter/receiver component 154; and so on) that, when executed by the respective processor can facilitate performance of operations (e.g., the operations discussed with respect to the various methods and/or systems discussed herein). Further, the respective processors can be utilized to execute computer executable components stored in the respective memories.

For example, the respective memories can store protocols associated with facilitating on-demand replay as discussed herein. Further, the respective memories can facilitate action to control communication between various devices of the data storage system 100 and other systems, user equipment, network equipment (e.g., the data manager VM 104, the data domain 106, and so on) one or more file storage systems, one or more devices, such that the data storage system 100 employ stored protocols and/or processes to achieve improved overall performance while facilitating on-demand replay as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

The respective processors can facilitate respective analysis of information related to facilitating on-demand replay. The respective processors can be processors dedicated to analyzing and/or generating information received, processors that controls one or more components of the data storage system 100, and/or processors that both analyze and generate information received and controls one or more components of the data storage system 100.

The respective transmitter/receiver components can receive one or more commands and/or response as discussed herein. The respective transmitter/receiver components can be configured to transmit to, and/or receive data from, for example, a user equipment (e.g., the UE 102), a client, network equipment (e.g., the data manager VM 104, the data domain 106), and other communication devices. Through the respective transmitter/receiver components, the data storage system 100 can concurrently transmit and receive data, can transmit and receive data at different times, or combinations thereof.

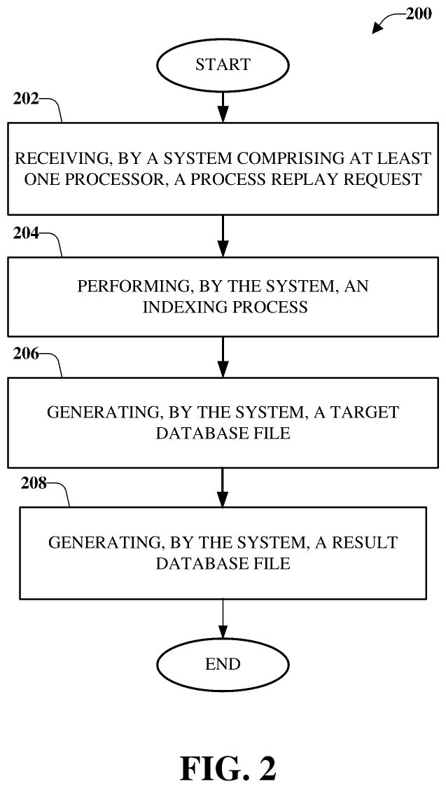

FIG. 2 illustrates an example, non-limiting, computer-implemented method 200 that facilitates on-demand indexing to allow for restoring backed-up files in advanced networks in accordance with one or more embodiments described herein. Repetitive description of like elements employed in other embodiments described herein is omitted for sake of brevity. The computer-implemented method 200 and/or other methods discussed herein can be implemented by network equipment comprising one or more processors. In an example, the computer-implemented method 200 and/or other methods discussed herein can be implemented by a client device and/or client machine. According to another example, the computer-implemented method can be implemented by a system (e.g., the data storage system 100, and so on) comprising at least one processor and at least one memory.

The computer-implemented method 200 starts at 202 when a process replay request is received. The request can be received from a user and/or entity (e.g., via the UE 102, via the user interface component 108) and can include one or more parameters or criteria (e.g., one or more filters) defining the assets to be restored. For example, the user can select (e.g., via the user interface component 108) one or more assets to restore from (e.g., which directories, such as a folders directory, and/or files to restore). Further, the user (e.g., via the user interface component 108) can select one or more filters, which can be utilized to narrow down the temporary indexes that are created in order to perform the restoration. For example, the one or more filters can include one or more wildcards for directories and/or files to restore. In an additional, or alternative, example, the one or more filters can include a date range of files from which the user has requested to be restored from (e.g., from January 2025 through March 2025, from Oct. 31, 2024, through Apr. 14, 2025, and so on).

Upon or after the request is received, at 204, an indexing process is performed. The indexing process can take anywhere from a few minutes to a day or longer to complete. The time needed to perform the indexing process is dependent on the size of the NAS share or the size of the FS. In some implementations, the indexing process performed at 204 uses Filesystem in Userspace (FUSE) to mount the DD storage unit directory using DD Boost Software Development Kit (SDK) to a local mount and then querying it based on the user filters to generate (e.g., create) a target SQ Lite Database file, at 206, for example.

Upon or after the target SQLite Database file is generated, a result database file is generated, at 208. According to some implementations, the result database file is managed on a data management system (e.g., a PowerProtect Data Manager (PPDM)). Upon or after the indexing process is completed, the user is presented with the information. For example, the user can be presented with the option to search the generated result set. According to some implementations, real-time updates related to the restored assets and/or generated result set (or a portion thereof) are transmitted to a client device (e.g., the UE 104), and causes the client device to activate a UI (e.g., the user interface component 108) with the time critical updated information so that the user becomes aware of the update to the restored assets and/or generated result set (or a portion thereof) in real-time. Further, the user or other entity can delete the generated result set when no longer needed and/or to free up resources (e.g., storage space, processing capabilities, and so on).

According to some implementations, a fixed disk-space can be reserved for storing replay databases, and once the allotted limit is reached, additional replays are not allowed, until previous ones are deleted.

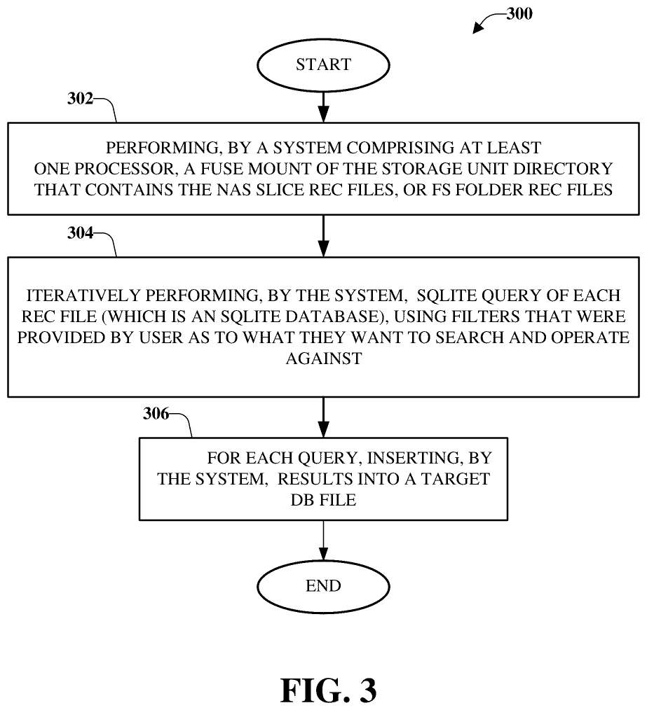

FIG. 3 illustrates an example, non-limiting, computer-implemented method 300 that facilitates an indexing process for on-demand indexing in accordance with one or more embodiments described herein. Repetitive description of like elements employed in other embodiments described herein is omitted for sake of brevity. The computer-implemented method 300 and/or other methods discussed herein can be implemented by network equipment comprising one or more processors. In an example, the computer-implemented method 300 and/or other methods discussed herein can be implemented by a client device and/or client machine. According to another example, the computer-implemented method can be implemented by a system (e.g., the data storage system 100, and so on) comprising at least one processor and a memory.

As discussed above, the user and/or other entity can initiate an indexing process, which can take from a few minutes to a day or more, depending on the size of the NAS share or FS. This process uses FUSE to mount the DD storage unit directory using DD Boost SDK to a local mount and then querying it based on the user filters to create a target SQLite Database file.

More specifically, the indexing process (e.g., performing the indexing process at 206 of FIG. 2) can include, at 302, performing a FUSE mount of the storage unit directory that contains the NAS slice REC files, or FS folder REC files. At 304, the computer-implemented method 300 Iteratively perform SQLITE query of each REC file (which is an SQLite database), using filters that were provided by the user as to what they want to search and operate against. Further, at 306, for each query, the computer-implemented method 300 inserts results into a target SQLITE DB file.

The disclosed embodiments solve a critical gating factor with respect to the indexing process. The problem to be solved includes making the indexing process (e.g., reading the various slices through FUSE mounting) performant such that the entire directory (potentially consisting of 1000s of DBs or more) may be read in a timely manner. In order to achieve this, a few techniques are provided herein. These techniques include, but are not limited to, setting the FUSE (and DD Boost) read block sizes to be large, ideally aligning with the DB record size. Another technique includes utilizing parallelism of reads using multiple DD Boost connections. Yet another technique is the checkpointing of DB reads to support failure resumption. In addition, another technique is limiting the target result-set to be a fixed limit (e.g., 10000 records).

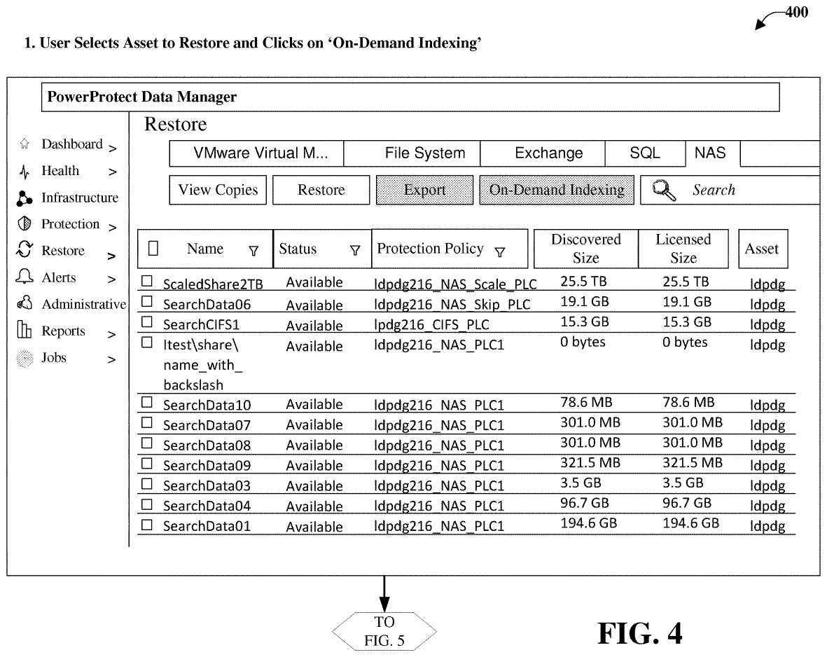

FIGS. 4-9 illustrate example, non-limiting, wireframes for an on-demand indexing workflow in accordance with one or more embodiments described herein. Repetitive description of like elements employed in other embodiments described herein is omitted for sake of brevity. It is noted that wireframes are visual, skeletal outlines of a website, application, or another digital product, focusing on the layout, structure, and functionality rather than visual design elements. The example wireframes of FIGS. 4-9 can be screen shots of a user interface in accordance with the various embodiments provided herein.

In further detail, FIG. 4 illustrates an example, non-limiting, user interface 400 depicting a first stage of a restoration process in accordance with one or more embodiments described herein. Repetitive description of like elements employed in other embodiments described herein is omitted for sake of brevity. The user interface 400 of FIG. 4 can be utilized as a user interface display screen, which can be rendered on user equipment (e.g., the UE 102). For example, the user interface 400 (or a similar (or different) user interface screen) can be output on a user interface (e.g., the user interface component 108). Although the wireframes of FIGS. 4-9 are for a NAS workflow, the disclosed embodiments are not limited to this implementation.

As depicted in the user interface 400 the user can interact with the display to select one or more assets to restore. According to some implementations, the user interface can be associated with a restore page of a NAS workflow. It is noted that the disclosed embodiments can be utilized with NAS and FSs, as well as other systems. Accordingly, there are a multitude of assets that can be backed up as discussed herein.

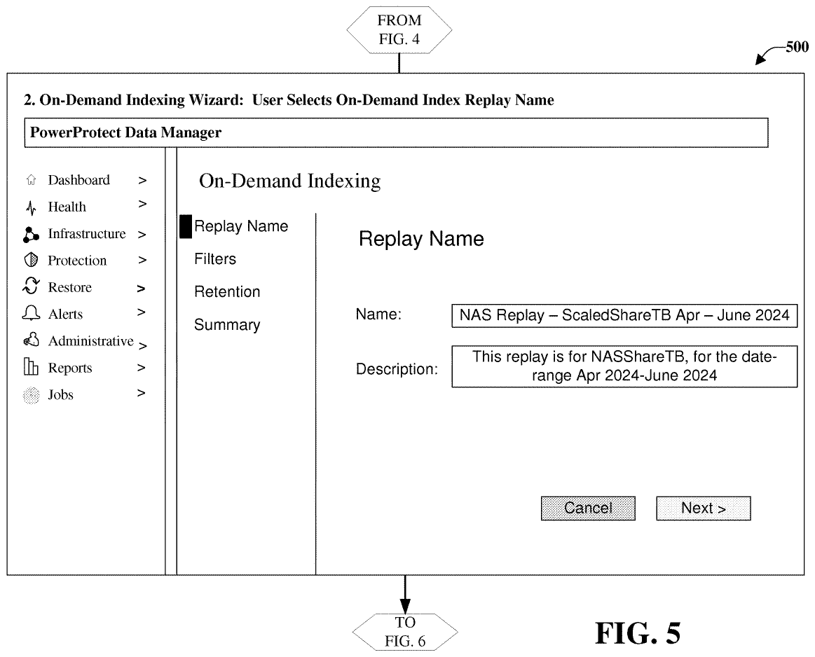

FIG. 5 illustrates an example, non-limiting, user interface 500 depicting a second stage of the restoration process in accordance with one or more embodiments described herein. Repetitive description of like elements employed in other embodiments described herein is omitted for sake of brevity.

The user interface 500 includes an on-demand indexing wizard, for example. The user can select an on-demand index replay name, which is a configurable name, which the user can modify, as desired. The user interface 500 also allows the user to describe details related to the replay. This is because, later on, this is going to be a job that can be monitored, managed, and otherwise interacted with by the user.

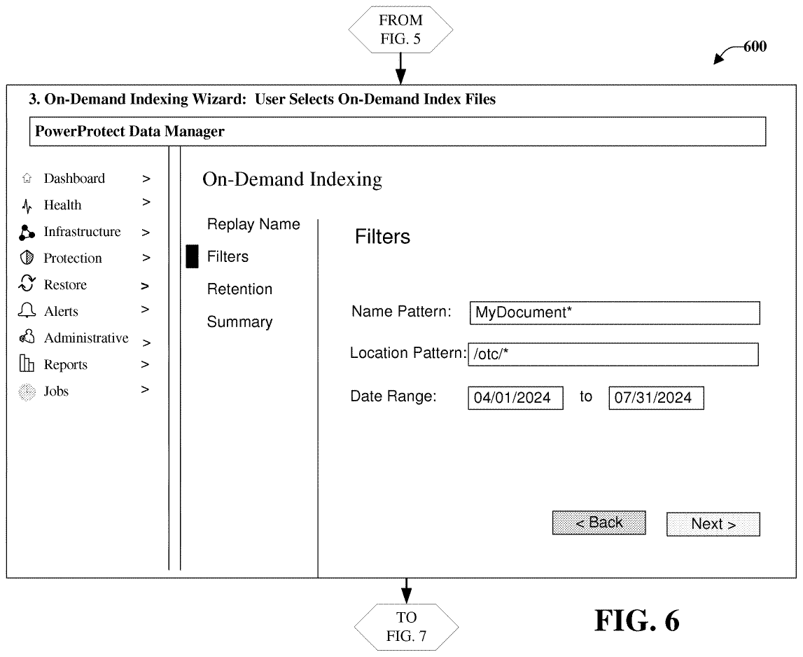

FIG. 6 illustrates an example, non-limiting, user interface 600 depicting a third stage of the restoration process in accordance with one or more embodiments described herein. Repetitive description of like elements employed in other embodiments described herein is omitted for sake of brevity.

The user interface 600 provides fields to allow the user to select one or more filters. For example, a filter can be whether the user cares about documents contained in the documents folder. In another example, a filter can be whether the user cares about Excel spreadsheets or what are the files that the user might want to restore later on. Therefore, the user defines the name, defines what dates ranges include the files that are to be searched against. Thus, one or more of these filters can be selected for the replay process. It is noted that although only a few filters are illustrated and described, other filters can be utilized based on the files to be restored and/or the criteria on which is to be replayed.

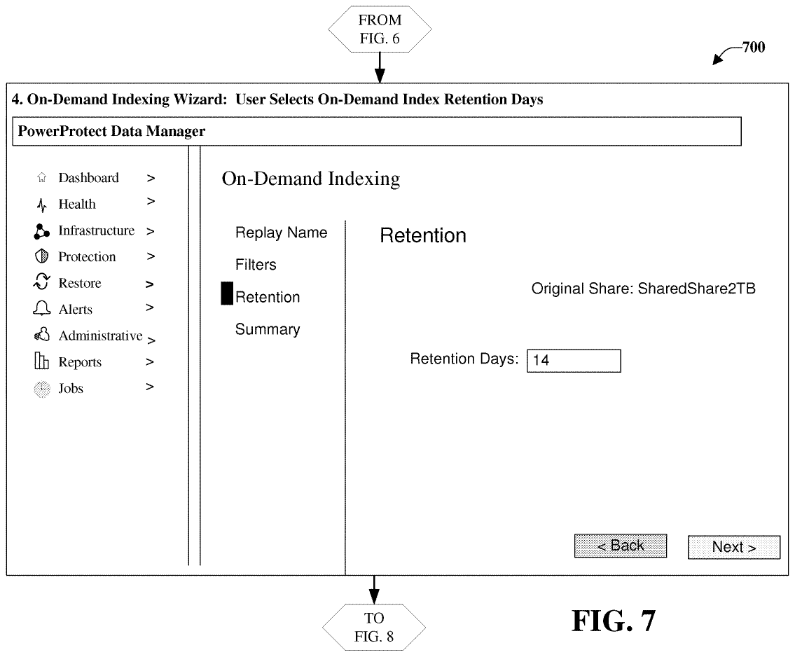

FIG. 7 illustrates an example, non-limiting, user interface 700 depicting a fourth stage of the restoration process in accordance with one or more embodiments described herein. Repetitive description of like elements employed in other embodiments described herein is omitted for sake of brevity.

The user interface 700 provides a selectable field for the user to select a retention period. In some implementations, the retention period can be expressed in a number of hours, a number of days, a number of months, or other time periods. Based on the selected time period, the replay will be automatically deleted after expiration of the defined time period. According to some implementations, the retention period can be “keep until deleted” or “do not delete.”

A defined retention period can be utilized to facilitate conservation of resources (e.g., storage space or capability), processing capability, and so on. For example, each time a replay is performed, the mirrored assets will occupy some disk space or storage space in a computer-readable storage medium. Accordingly, if the user only needs to replay for a limited amount of time (e.g., 14 days) and after that it can be deleted, such information can be utilized to manage the replays in the system and free up system resource (e.g., reclaim memory space).

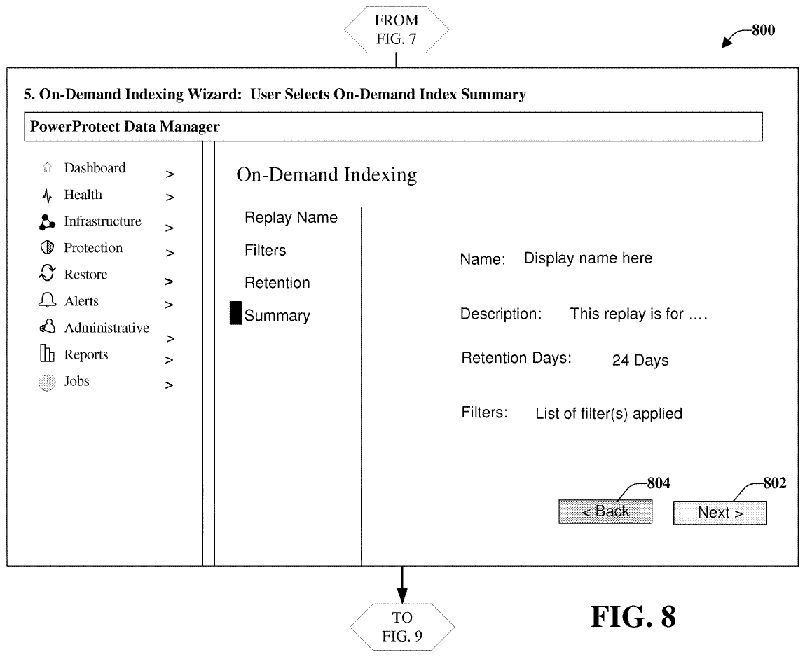

FIG. 8 illustrates an example, non-limiting, user interface 800 depicting a fifth stage of the restoration process in accordance with one or more embodiments described herein. Repetitive description of like elements employed in other embodiments described herein is omitted for sake of brevity.

The user interface 800 can provide information related to the replay, which can be reviewed in real-time. If the information is accurate, the user can select an electronic submission button 802. Alternatively, if changes should be made, the user can select an electronic back button 804. Upon or after the electronic submission button 802 is activated, the replay can be initiated.

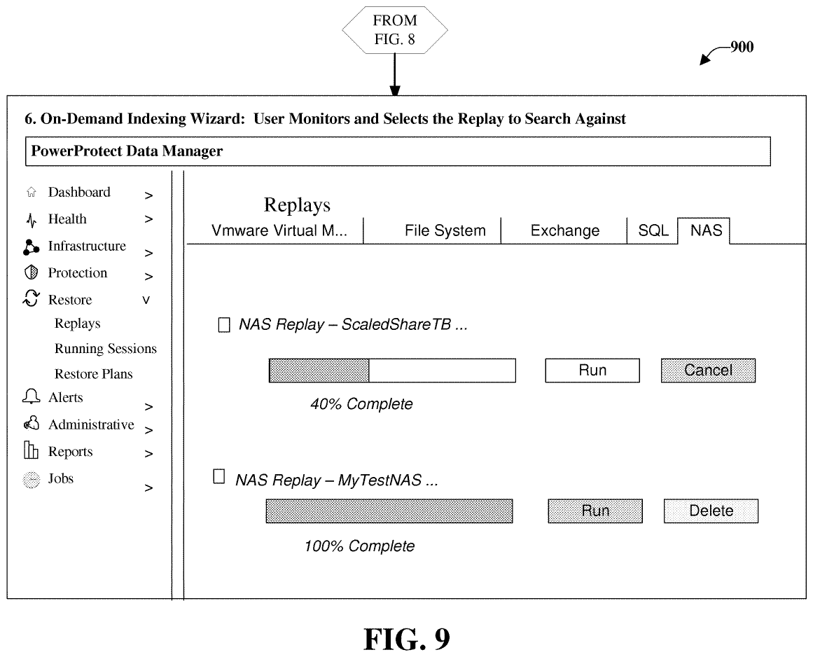

FIG. 9 illustrates an example, non-limiting, user interface 900 depicting a sixth stage of the restoration process in accordance with one or more embodiments described herein. Repetitive description of like elements employed in other embodiments described herein is omitted for sake of brevity.

The user interface 900 renders a list of replays that are in process and/or replays that have been completed and are ready for use. If a replay is in process, the user interface 900 can render details related to the progress of the replay, which may take a few hours to complete in some instances. The amount of time needed to process the replay can be a function of the size of the asset that the user wants to replay against.

The user interface 900 allows the user an opportunity to manage the one or more replays. For example, a replay can be canceled. In another example, a replay can be deleted if no longer needed and/or if it is taking up too much space.

FIG. 10 illustrates an example, non-limiting, system 1000 for facilitating on-demand indexing to allow for restoring backed-up files for NAS and fs (filesystem) in advanced networks in accordance with one or more embodiments described herein. Repetitive description of like elements employed in other embodiments described herein is omitted for sake of brevity. The system 1000 can comprise one or more of the components and/or functionality of the computing devices of the systems and/or the computer-implemented methods discussed herein, and vice versa.

As previously mentioned, although various aspects are discussed with a NAS deployment for purposes of explanation, the disclosed aspects are not limited to this implementation.

The system 1000 includes a data disk (DD) storage unit 1002 and a local host 1004. The DD storage unit 1002 includes a DB storage directory 1006. The DB storage directory 1006 can include multiple databases identified in FIG. 10 as a first database (DB 1), a second database (DB 2), a third database (DB 3), a fourth database (DB 4), through an Nth database (DB N), where N is an integer. It is noted that the DB storage directory can include fewer than four databases according to some implementations.

All the data is stored in the data domain system (e.g., the DD storage unit 1002). The storage unit (e.g., the DD storage unit 1002) is the location in the system 1000 where the data is stored (e.g., wherein the NAS files are stored). When an asset is archived, there are multiple databases that are stored in this data domain.

NAS consists of shared storage (sometimes referred to as a “share”). The hierarchy is that the share includes items (referred to as slices) under it. The share and the associated slices can be similar to a directory structure, and can be thought of as a “tree” structure. Accordingly, there is a share with a multitude of slices. In each slice, there will be a multitude of records (or assets), such as the DB files.

At 1008, the system 1000 is iteratively mounting the slice (e.g., the share directory). Upon or after the slice is mounted, the DB files are read, one-by-one, using the filters defined by the user, as indicated at 1010. The results are then placed in a temporary results database file, at 1012. Accordingly, the system 1000 is accessing the assets, reading each asset individually, making sure the asset matches the defined filter(s), and then creates the temporary storage. Thus, the temporary storage is a subset of the data in a database so that the user can query that subset and then find the files that should be restored.

As mentioned, a FUSE mount is being utilized with the disclosed embodiment. For the Fuse mount, there are a multitude of files in the directory and the files are being mirrored on the local directory. In the background there are processes being performed, such as when the kernel performing a read operation on a local host, it is actually going to the remote machine and then doing a read at the remote machine, but it is similar to a mirror of the remote directory.

This is the part that will potentially take a lot of time. There could be thousands of DB files on the DB storage unit. Therefore, instead of just creating one data channel to the DD storage, multiple channels are being established and utilized (e.g., multiple fuse mounts, parallelism). Accordingly, there will be multiple of these mount points created. The multiple data channels are utilized to speed up the process. Otherwise, if only one data channel is utilized, the process will be really slow to iteratively go through thousands of files.

Additionally, there can be failures encountered during the replay process. At some point, for example, the network becomes unavailable and the reads during the replay process are disabled. Instead of having the start the read operations all over again, one or more checkpoints can be utilized. The checkpoints can maintain a history of the assets that have been read and what assets have been stored. The checkpoints can be utilized to restart from where the read operation was at prior to the network disruption.

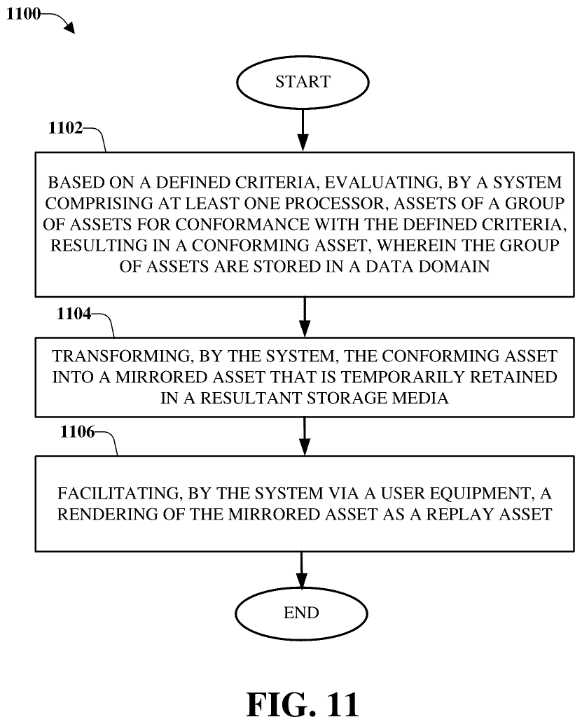

FIG. 11 illustrates an example, non-limiting, computer-implemented method 1100 that facilitates on-demand restoration of assets based on one or more criteria in advanced networks in accordance with one or more embodiments described herein. Repetitive description of like elements employed in other embodiments described herein is omitted for sake of brevity. The computer-implemented method 1100 and/or other methods discussed herein can be implemented by network equipment comprising one or more processors. In an example, the computer-implemented method 1100 and/or other methods discussed herein can be implemented by a client device and/or client machine. According to another example, the computer-implemented method can be implemented by a system (e.g., the data storage system 100, the system 1000, and so on) comprising at least one processor and a memory.

The computer-implemented method 1100 includes, at 1102, based on at least one defined criterion, evaluating, by a system comprising at least one processor, assets of a group of assets for conformance with the at least one defined criterion, resulting in a conforming asset. The group of assets are stored in a data domain.

According to some implementations, the computer-implemented method 1100 can include assigning, by the system, checkpoints at defined stages of the evaluation. The checkpoints are restore points from which a restart of the evaluation is able to resume after a stoppage of the evaluating.

According to some implementations, prior to the evaluating, the computer-implemented method 1100 can include receiving, by the system, a request for replay of at least a portion of the assets of the group of assets. The request for replay can include information indicative of the at least one defined criterion. In an example, a criterion of the at least one defined criterion comprises a date range. In another example, a criterion of the at least one defined criterion comprises information indicative of one or more file folders. According to yet another example, a criterion of the at least one defined criterion comprises information indicative of one or more directories.

According to some implementations, the evaluating can include using multiple connection channels to access the data domain. The multiple connection channels can facilitate parallelism, which can allow multiple assets to be evaluated at a same time or at substantially the same time. Further, the multiple connection channels can decrease an amount of time to perform the replication of data.

Further, at 1104, the computer-implemented method 1100 transforms, by the system, the conforming asset into a mirrored asset that is temporarily retained in at least one resultant storage medium. According to some implementations, the transformation can include mirroring the conforming asset into the mirrored asset that is temporarily retained in the at least one resultant storage medium.

The computer-implemented method 1100 also includes facilitating, by the system via a user equipment, a rendering of the mirrored asset as a replay asset. According to some implementations, the computer-implemented method 1100 can include defining, by the system, a storage threshold applicable to the mirrored asset and other mirrored assets other than the mirrored asset. Further to these implementations and based on a determination that the storage threshold is satisfied, the computer-implemented method 1100 can include deleting, by the system, the mirrored asset from the at least one resultant storage medium.

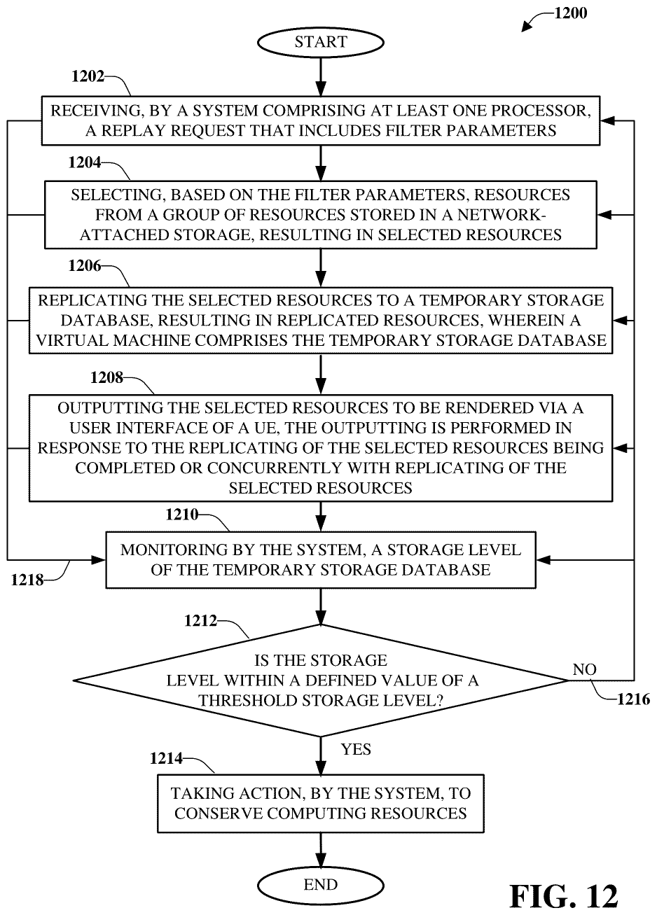

FIG. 12 illustrates an example, non-limiting, computer-implemented method 1200 that facilitates on-demand replay to allow for restoring backed-up files while conserving computing resources in advanced networks in accordance with one or more embodiments described herein. Repetitive description of like elements employed in other embodiments described herein is omitted for sake of brevity. The computer-implemented method 1200 and/or other methods discussed herein can be implemented by network equipment comprising one or more processors. In an example, the computer-implemented method 1200 and/or other methods discussed herein can be implemented by a client device and/or client machine. According to another example, the computer-implemented method can be implemented by a system (e.g., the data storage system 100, the system 1000, and so on) comprising at least one processor and a memory.

The computer-implemented method 1200 starts, at 1202, with receiving a replay request that includes filter parameters (e.g., criteria). The filter parameters can be entered by a user and/or entity via, for example, a user interface (e.g., the user interface component 108) associated with user equipment (e.g., the UE 102). For example, the filter parameters can be user-configurable parameters associated with the group of assets. The filter parameters can include, but are not limited to, a data range, first information indicative of file folders, and second information indicative of directories.

The computer-implemented method 1200 continues, at 1204, with selecting, based on the filter parameters, assets from a group of assets stored in a network-attached storage, resulting in selected assets. The selecting can include fuse mounting a storage unit directory that comprises network-attached storage slices retained in the network-attached storage. According to some implementations, the fuse mounting can include establishing multiple data channels between the network-attached storage and the virtual machine.

Upon or after the assets are selected, the computer-implemented method 1200 replicates, at 1206, the selected assets to a temporary storage database, resulting in replicated assets. A virtual machine includes the temporary storage database.

The selected assets are output, at 1208, to be rendered via a user interface of a user equipment. The output of the selected assets is performed in response to the replicating of the selected assets being completed or concurrently with the replicating of the selected assets.

The computer-implemented method 1200 continues, at 1210, with monitoring a storage level of the temporary storage database. A determination is made, at 1212, whether the storage level is within a defined value of a threshold storage level. For example, the determination can be whether the amount of storage being used is approaching a maximum amount of storage reserved for replay processing as discussed herein. The defined level can be a percentage or another manner of determining if the amount of data retained in the temporary storage database is reaching the threshold storage level (e.g., 90% of the threshold storage level is used, 98% of the threshold storage level is used, and so on).

If it is determined at 1212 the storage level is within the defined value of a threshold storage level (“YES”), at 1214, action is taken to conserve computing resources. For example, an action taken can be to temporarily disable a replay process. In another example, an action can be to delete the selected assets from the temporary storage database. In another example, an action can be to delete selected assets based on age or how long the selected assets (for a particular replay process) have been retained in the temporary storage database. In yet another example, an action can be to deleted selected assets of an identified replay process based on no interaction with those selected assets (or that identified replay process) in a defined amount of time (e.g., one week, three weeks, two months, one year, and so on).

Alternatively, if it is determined at 1212 that the storage level is not within the defined value of a threshold storage level (“NO”), the computer-implemented method 1200 can return to 1202 with receiving a replay request, or can return to another portion of the computer-implemented method 1200, as indicated by line 1216.

It is noted that although depicted and described with respect to the monitoring of the storage level being performed after the selected assets are output at 1208, the determination can be made at any time, as indicated by line 1218. Further, it is to be understood that the determination, at 1212, related to the amount of temporary storage being used can be recursive, such that any number of determinations can be made.

It should be noted that terms such as “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

Accordingly, as discussed herein, provided is on-demand replay to allow for restoring backed-up files in advanced networks. The disclosed embodiments perform a restore operation on some files through a search interface and an amount of storage and CPU requirements for performing the replay can be greatly reduced by soliciting the user for a narrow date range or list of assets for which the user wants to perform the restore operation. The disclosed embodiments also facilitate a workflow to solicit various filter parameters from the user and allow for some time to perform on-demand indexing of desired metadata.

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” “data store” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (ISCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

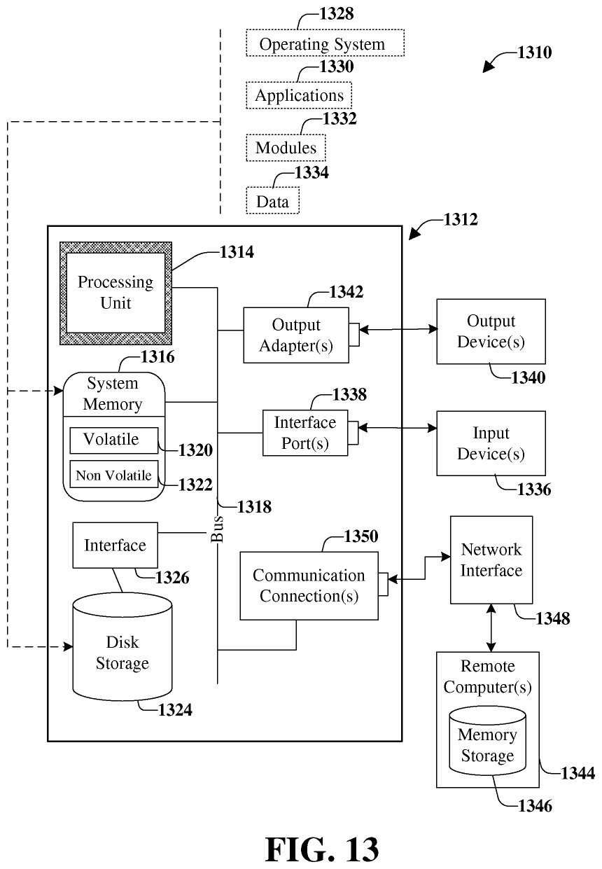

In order to provide a context for the various aspects of the disclosed subject matter, FIG. 13 as well as the following discussion are intended to provide a brief, general description of a suitable environment in which the various aspects of the disclosed subject matter can be implemented.

With reference to FIG. 13, an example environment 1310 for implementing various aspects of the aforementioned subject matter comprises a computer 1312. The computer 1312 comprises a processing unit 1314, a system memory 1316, and a system bus 1318. The system bus 1318 couples system components including, but not limited to, the system memory 1316 to the processing unit 1314. The processing unit 1314 can be any of various available processors. Multi-core microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (A GP), Personal Computer Memory Card International Association bus (PCM CIA), and Small Computer Systems Interface (SCSI).

The system memory 1316 comprises volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can comprise read only memory (ROM), programmable ROM (PROM), electrically programmable ROM (EPROM), electrically erasable PROM (EEPROM), or flash memory. Volatile memory 1320 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also comprises removable/non-removable, volatile/non-volatile computer storage media. FIG. 13 illustrates, for example, a disk storage 1324. Disk storage 1324 comprises, but is not limited to, devices like a magnetic disk drive, floppy disk drive, tape drive, Jaz drive, Zip drive, LS-100 drive, flash memory card, or memory stick. In addition, disk storage 1324 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1324 to the system bus 1318, a removable or non-removable interface is typically used such as interface 1326.

According to some implementations, the example environment 1310 can include non-transitory machine-readable medium, comprising executable instructions that, when executed by at least one processor of network equipment, facilitate performance of operations. The operations can include receiving a selection of filters associated with a replay request. Based on the replay request and the selection of filters, the operations can include reading a group of data assets of a database storage directory. The reading is performed individually for respective data assets of the group of data assets. The operations can also include, based on a determination that a data asset of the group of data assets satisfies the selection of filters, replicating the data asset to a temporary database of a virtual machine, resulting in a replicated data asset. The temporary database is a searchable database. In addition, the operations can include rendering, via a user interface, the replicated data asset in response to the replay request.

According to an implementation, the receiving can include receiving the selection of filters via an interactive user interface. In accordance with some implementations, the replay request comprises an instruction to restore back-up files from a network attached storage database.

It is to be appreciated that FIG. 13 describes software that acts as an intermediary between users and the basic computer resources described in suitable operating environment 1310. Such software comprises an operating system 1328. Operating system 1328, which can be stored on disk storage 1324, acts to control and allocate resources of the computer 1312. System applications 1330 take advantage of the management of resources by operating system 1328 through program modules 1332 and program data 1334 stored either in system memory 1316 or on disk storage 1324. It is to be appreciated that one or more embodiments of the subject disclosure can be implemented with various operating systems or combinations of operating systems.

A user enters commands or information into the computer 1312 through input device(s) 1336. Input devices 1336 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 comprise, for example, a serial port, a parallel port, a game port, and a universal serial bus (USB). Output device(s) 1340 use some of the same type of ports as input device(s) 1336. Thus, for example, a USB port can be used to provide input to computer 1312, and to output information from computer 1312 to an output device 1340. Output adapters 1342 are provided to illustrate that there are some output devices 1340 like monitors, speakers, and printers, among other output devices 1340, which require special adapters. The output adapters 1342 comprise, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically comprises many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the system bus 1318. While communication connection 1350 is shown for illustrative clarity inside computer 1312, it can also be external to computer 1312. The hardware/software necessary for connection to the network interface 1348 comprises, for exemplary purposes only, internal, and external technologies such as, modems including regular telephone grade modems, cable modems and DSL modems, ISDN adapters, and Ethernet cards.

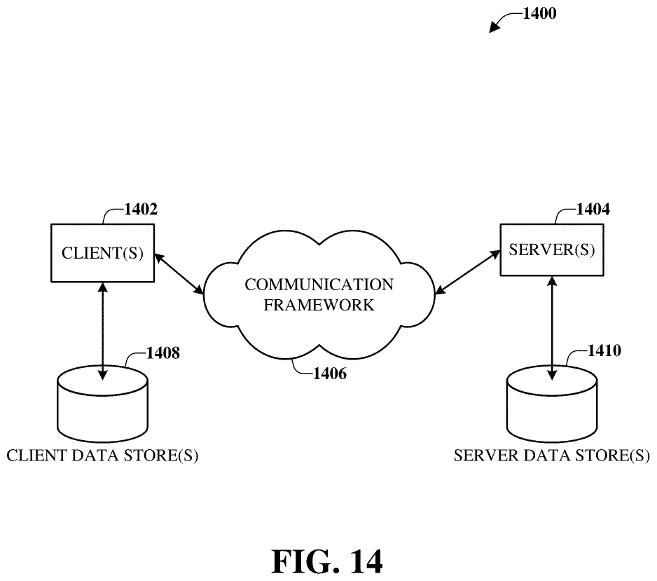

FIG. 14 is a schematic block diagram of a sample computing environment 1400 with which the disclosed subject matter can interact. The sample computing environment 1400 includes one or more client(s) 1402. The client(s) 1402 can be hardware and/or software (e.g., threads, processes, computing devices). The sample computing environment 1400 also includes one or more server(s) 1404. The server(s) 1404 can also be hardware and/or software (e.g., threads, processes, computing devices). The servers 1404 can house threads to perform transformations by employing one or more embodiments as described herein, for example. One possible communication between a client 1402 and servers 1404 can be in the form of a data packet adapted to be transmitted between two or more computer processes. The sample computing environment 1400 includes a communication framework 1406 that can be employed to facilitate communications between the client(s) 1402 and the server(s) 1404. The client(s) 1402 are operably connected to one or more client data store(s) 1408 that can be employed to store information local to the client(s) 1402. Similarly, the server(s) 1404 are operably connected to one or more server data store(s) 1410 that can be employed to store information local to the servers 1404.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, random access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray DISC™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
based on at least one defined criterion, evaluating, by a system comprising at least one processor, assets of a group of assets for conformance with the at least one defined criterion, resulting in a conforming asset, wherein the group of assets is stored in a data domain;
transforming, by the system, the conforming asset into a mirrored asset that is temporarily retained in at least one resultant storage medium;
conveying, by the system to a user equipment, the mirrored asset as a real-time update as the assets of the group of assets are transformed into the mirrored asset;
based on the conveying of the mirrored asset as the real-time update, activating, by the system via the user equipment, an interface of the user equipment and rendering, via the interface, the mirrored asset as a replay asset;
defining, by the system, a storage threshold that is applicable to the mirrored asset and other mirrored assets other than the mirrored asset based on user interactions with the mirrored asset: and
based on a determination that the storage threshold is satisfied due to no user interaction with the mirrored asset occurring during a defined amount of time, deleting, by the system, the mirrored asset from the at least one resultant storage medium.

2. The method of claim 1, further comprising:
prior to the evaluating, receiving, by the system, a request for replay of at least a portion of the assets of the group of assets, the request for replay comprising information indicative of the at least one defined criterion.

3. The method of claim 2, wherein a criterion of the at least one defined criterion comprises a date range.

4. The method of claim 2, wherein a criterion of the at least one defined criterion comprises information indicative of one or more file folders.

5. The method of claim 2, wherein a criterion of the at least one defined criterion comprises information indicative of one or more directories.

6. The method of claim 1, further comprising:
assigning, by the system, checkpoints at defined stages of the evaluating, wherein a defined stage of the defined stages is determined each time an asset of the group of assets is read, and wherein the checkpoints are restore points from which a restart of the evaluating is able to resume after a stoppage of the evaluating.

7. The method of claim 1, wherein the assets are retained in a network-attached storage, and wherein the evaluating comprises:
using, by the system, multiple parallel connection channels to access the data domain, wherein the multiple parallel connection channels are established between the network-attached storage and a virtual machine.

8. (canceled)

9. (canceled)

10. The method of claim 1, wherein the transforming comprises mirroring the conforming asset into the mirrored asset that is temporarily retained in the at least one resultant storage medium.

11.-20. (canceled)

21. The method of claim 1, further comprising:
based on receipt of an indication that the mirrored asset is to be removed from the at least one resultant storage medium, deleting, by the system, the mirrored asset from the at least one resultant storage medium.

22. The method of claim 1, wherein the rendering, via the interface, of the mirrored asset as the replay asset comprises outputting a visual representation of a restore page of a network-attached storage workflow.

23. A system, comprising:
at least one processor; and
at least one memory that stores executable instructions that, when executed by the at least one processor, facilitate performance of operations, comprising:
based on at least one filter parameter, evaluating assets of a group of assets for conformance with the at least one filter parameter, resulting in a conforming asset, wherein the group of assets is stored in a data domain;
converting the conforming asset into a mirrored asset that is temporarily retained in at least one resultant storage medium;
transmitting, to a user equipment, the mirrored asset as a real-time update as the assets of the group of assets are transformed into the mirrored asset;
based on the transmitting of the mirrored asset as the real-time update, activating, via the user equipment, an interface of the user equipment and rendering, via the interface, the mirrored asset as a replay asset;
defining a storage threshold for the mirrored asset and other mirrored assets other than the mirrored asset based on user interactions with the mirrored asset; and
based on a determination that the storage threshold is satisfied due to no user interaction with the mirrored asset occurring during a defined amount of time, deleting the mirrored asset from the at least one resultant storage medium.

24. The system of claim 23, wherein the operations further comprise:
prior to the evaluating, receiving a request for replay of at least a portion of the assets of the group of assets, the request for replay comprising information indicative of the at least one filter parameter.

25. The system of claim 24, wherein a filter parameter of the at least one filter parameter comprises first information indicative of one or more file folders, or second information indicative of one or more directories.

26. The system of claim 24, wherein the operations further comprise:
assigning checkpoints at defined stages of the evaluating, wherein a defined stage of the defined stages is determined each time an asset of the group of assets is read, and wherein the checkpoints are restore points from which a restart of the evaluating is able to resume after a stoppage of the evaluating.

27. The system of claim 23, wherein the assets are retained in a network-attached storage, and wherein the evaluating comprises:
using multiple parallel connection channels to access the data domain, wherein the multiple parallel connection channels are established between the network-attached storage and a virtual machine.

28. The system of claim 23, wherein the transforming comprises mirroring the conforming asset into the mirrored asset that is temporarily retained in the at least one resultant storage medium.

29. The system of claim 23, wherein the rendering, via the interface, of the mirrored asset as the replay asset comprises outputting a visual representation of a restore page of a network-attached storage workflow.

30. A non-transitory machine-readable medium, comprising executable instructions that, when executed by at least one processor of network equipment, facilitate performance of operations, the operations comprising:
based on at least one defined criterion, evaluating assets of a group of assets for conformance with the at least one defined criterion, resulting in a conforming asset, wherein the group of assets is stored in a data domain;
transforming the conforming asset into a mirrored asset that is temporarily retained in at least one resultant storage medium;
sending, to a user equipment, a transmission of the mirrored asset as a real-time update as the assets of the group of assets are transformed into the mirrored asset;
based on the sending of the transmission of the mirrored asset as the real-time update, activating via the user equipment, an interface of the user equipment and rendering, via the interface, the mirrored asset as a replay asset;
defining a storage threshold that is applicable to the mirrored asset and other mirrored assets other than the mirrored asset based on user interactions with the mirrored asset; and
based on a determination that the storage threshold is satisfied due to no user interaction with the mirrored asset occurring during a defined amount of time, deleting the mirrored asset from the at least one resultant storage medium.

31. The non-transitory machine-readable medium of claim 30, wherein the operations further comprise:
assigning checkpoints at defined stages of the evaluating, wherein a defined stage of the defined stages is determined each time an asset of the group of assets is read, and wherein the checkpoints are restore points from which a restart of the evaluating is able to resume after a stoppage of the evaluating.

32. The non-transitory machine-readable medium of claim 30, wherein the assets are retained in a network-attached storage, and wherein the evaluating comprises:
using multiple parallel connection channels to access the data domain, wherein the multiple parallel connection channels are established between the network-attached storage and a virtual machine.
